(19) United States
(12) Patent Application Publication
(10) Pub. No.: US 2004/0103364 A1
(43) Pub. Date: May 27, 2004

(54) Method of an action occurring as a result of dragging and dropping a defined object within a web page

(76) Inventor: Jason Robert Dornback, Carrollton, TX (US)

Correspondence Address: Jason Dornback, 2116 Sonata Lane, Carrollton, TX, 75007, US

(21) Appl. No.: 10/303,140

(22) Filed: Nov. 25, 2002

(51) Int. Cl. G06F 15/00

(52) U.S. Cl. 715/501.1; 715/530; 715/515

(57) ABSTRACT

Using this invention, multiple objects may be defined on a web page. An object is a collection of HTML code, which may include text, hyperlinks, forms, images, tables, Java Applets, Java Script, Flash content, Shockwave content, video content or other web page components. Each defined object may be dragged to a new location on the web page and dropped. The new location of the dragged object may on top of another defined object on the web page, or into one of multiple defined regions within the web page. If an object is dropped onto a target object, specific software code can be executed, depending on which object is dragged initially, and which object is the target. If an object is dropped onto a defined region of the web page, specific software code can be executed depending on which object is dropped into which region.

### RELATED PATENTS

“Method to customize the appearance of a web page by dragging and dropping objects within a page.” Filing receipt: Jc872 U.S. PTO 09/955449 Sep. 19, 2001

“The method of dragging and dropping defined objects to or from a web page.”Provisional filing receipt: Jc973 U.S. PTO 60/350001 Jan. 23, 2002

“The method of an action occurring as a result of dragging and dropping a defined object within a web page.” Initial previous provisional filing receipt: jc996 U.S. PTO 60/323789 Sep. 21, 2001

### FIELD OF THE INVENTION

The present invention relates generally web pages, and more particularly to an innovative method and system for allowing software code to be executed after an object is dragged to a new location within the web page. Specific software code may be executed depending on the dragged object, the target object, or defined target regions.

### BACKGROUND OF THE INVENTION

The Internet is a worldwide system of computer networks—a network of networks in which users at any one computer can, if is has permission, get information from any other computer. Intranets are similar services that are available on private local area networks (LANs). The World Wide Web (WWW) and similar private architectures provide a “web” of interconnected documents, called “web pages” on intranets and the internet.

Web pages are typically made up of HyperText Markup Language (HTML) tags displaying HTML source files containing the headings, data, text, footings and hyperlinks to other web pages. An HTML document includes a hierarchical set of markup elements; most elements have a start tag, followed by content, followed by an end tag. The content is a combination of text and nested markup tags. HTML tags, which are enclosed in angle brackets (‘<’ and ‘>’), indicate how the document is structured and how to display the document, as well as destinations and labels for hypertext links. There are tags for markup elements such as titles and headers, text attributes such as bold, italic, lists, paragraph boundaries, links to other documents or other parts of the same document, inline graphic images, and for many other features.

Javascript provides a way to include programs, which are downloaded in a Web page, enabling the user to change some page properties. More information about javascript and the Java programming language may be found in Java in a Nutshell by David Flanagan, published by O'Reilly & Associates .COPYRGT.1996.

Web server software languages such as Active Server Pages (ASP), Java Server Pages (JSP), or ColdFusion are software languages that are executed on the web server. They provide a method for determining what content to serve to the client computer. These languages also provide interfaces to the web server resources, such as files or databases stored on the server. Such software languages also provide methods of sending, retrieving, and processing information sent to and from web pages.

### SUMMARY OF THE INVENTION

This invention allows software code to be executed after a user drags and drops a defined object within a web page. The name of the dragged object and name of the target object is recognized. The new location of the dropped object is also recognized. If a dragged object is dropped onto another object, specific software code can be executed depending on which object is dragged initially, and which object is the target of the dropped object. Specific code can also be executed if the object is dropped within defined regions of the web page.

### BRIEF DESCRIPTION OF THE DRAWINGS

FIG. 1 The web page prior to user moving objects.

FIG. 2 The same web page after user has moved objects.

FIG. 3 ASP code to define the multiple regions within the web page.

FIG. 4 ASP function to determine if an object was dropped within a specific region.

FIG. 5 ASP code to execute specific code if an object was dropped within a defined region.

FIG. 6 ASP code to execute specific code if an object was dropped onto another object.

FIG. 7 The entire Demo5.asp file source code.

### DETAILED DESCRIPTION OF THE INVENTION

The present invention allows software code to be executed after a user drags and drops a defined object within a web page. An object may be any combination of HTML code displayed to the user such as formatted text, hyperlinks, forms, images, tables, Java Applets, Java Script, Flash content, Shockwave content, video content or other web page components.

The name of the dragged object and name of the target object is recognized. The new location of the dropped object is also recognized. Specific software code can be executed depending on which object is dragged. If a dragged object is dropped onto another object, specific software code can be executed depending on which object is the target of the dropped object. Specific code can also be executed if the object is dropped within defined regions of the web page.

The following samples are written in a combination of Active Server Pages (ASP), HTML, and Javascript; although this technology is not limited to these software languages.

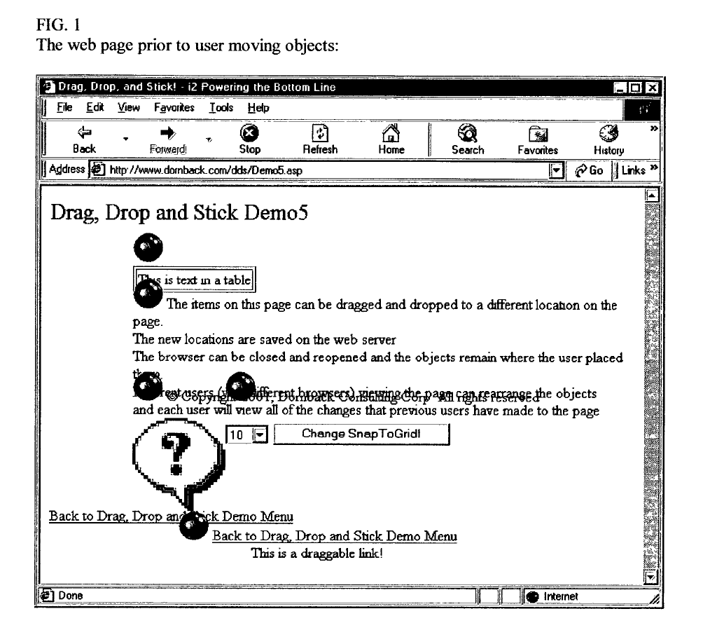

FIG. 1 shows the sample web page “Demo5.asp” as it is displayed when initially loaded in a web browser. There are multiple objects on the page that may be dragged and dropped to new locations by the user within the web page. The dragging and dropping of the objects within the web page is accomplished by tracking the mouse events with javascript. The following objects are defined on this web page:

Object0: Text in a Table

Object1: Description Text

Object2: Copyright

Object3: Big Questionmark

Object4: Main Menu Link

Object5: ChangeSnapToGrid

Each of the defined objects can be dragged and dropped with the mouse to new locations within the web page.

The following regions are defined on this web page:

Region0: defined as (0,0) to (200,200)

Region1: defined as (100,100) to (300,300)

Region2: defined as (200,200) to (400,400)

Region3: defined as (300,300) to (500,500)

Notice that the defined regions may overlap.

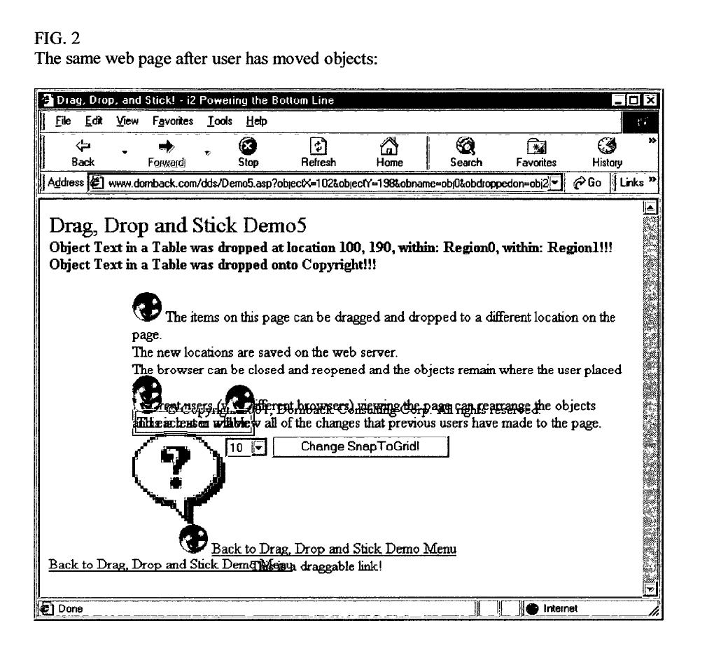

FIG. 2 shows the same web page after the object “Text in a Table” was dragged and dropped to location 100, 190. The new location of the object was on top of object “Copyright” and within two overlapping defined regions: “Region0” and “Region1”. Specific software code was executed to display the new location of the object, the object that was the target of the drop, and the names of both of the defined regions in which the object was dropped. If an object is dropped at a location that is defined within multiple regions, different code can be executed for each region, in addition to specific code being executed if the object is dropped onto another object.

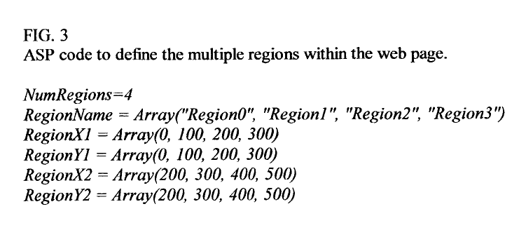

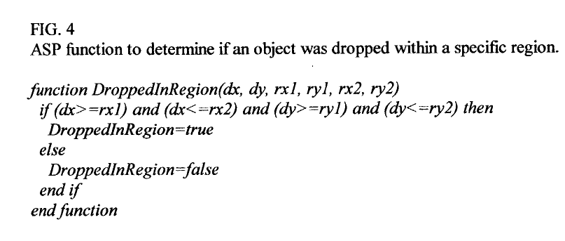

FIG. 3 shows the ASP code to define the multiple regions within the web page. For this example, the regions are defined using arrays. Each region is defined by two sets of coordinates. The variables RegionX1 and RegionY1 define the top-left coordinate of the region. The variables RegionX2 and RegionY2 define the bottom-right coordinate of the region. The two sets of coordinates are used to define a rectangle within the web page. All coordinates within the defined rectangle are included in the defined region. Each region is encompassed by one of the defined rectangles. Multiple defined regions may overlap each other within the page.

FIG. 4 shows the ASP function “DroppedInRegion”. This function determines if an object was dropped within a specific region by determining whether a given set of coordinates (dx, dy) is contained with a defined rectangular region (rx1, ry1, rx2, ry2). If the coordinates are within the region, the function returns “TRUE”. If the coordinates are not within the defined region, the function returns “FALSE”.

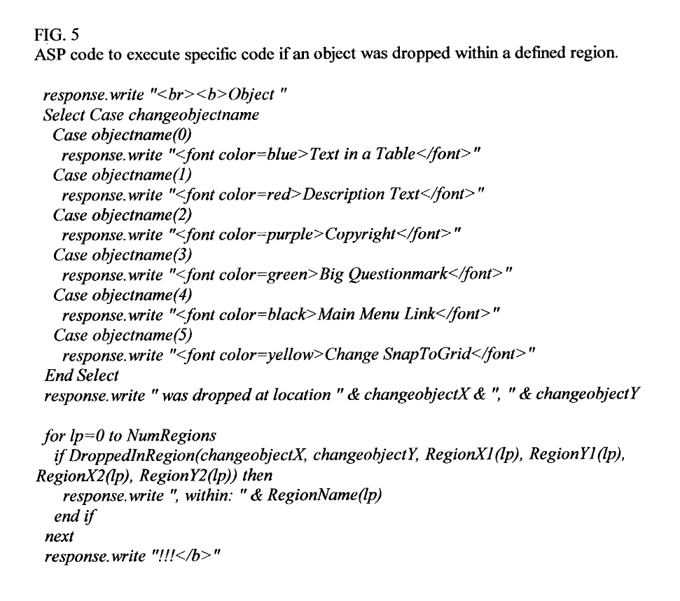

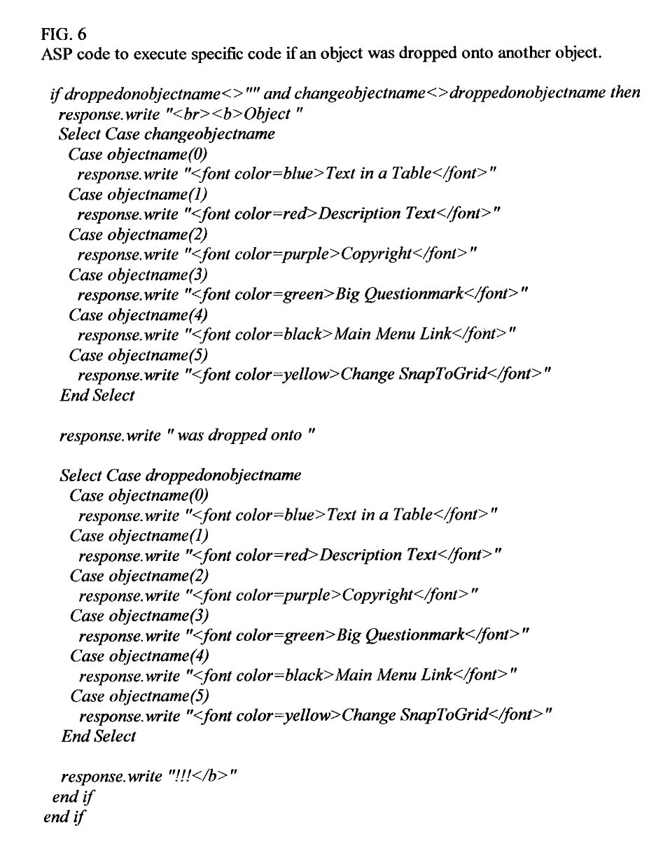

FIG. 5 shows the ASP code that is executed after an object is dropped in a new location within a web page. The code determines which object was dropped and executes code that displays the object name in different colors. It then calls the “DroppedInRegion” function for each of the defined regions within the web page. If the object was dropped within one or more of the defined regions, code is executed to display the name of the region(s).

FIG. 6 shows the ASP code that determines if an object was dropped onto another object, and executes specific code depending on the dropped object and the target object.

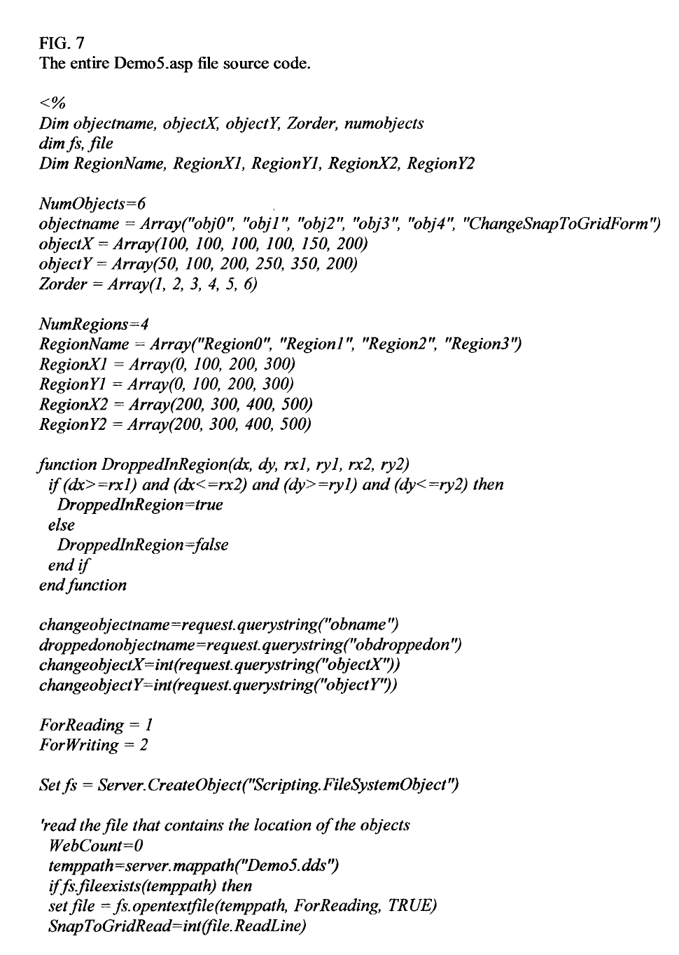

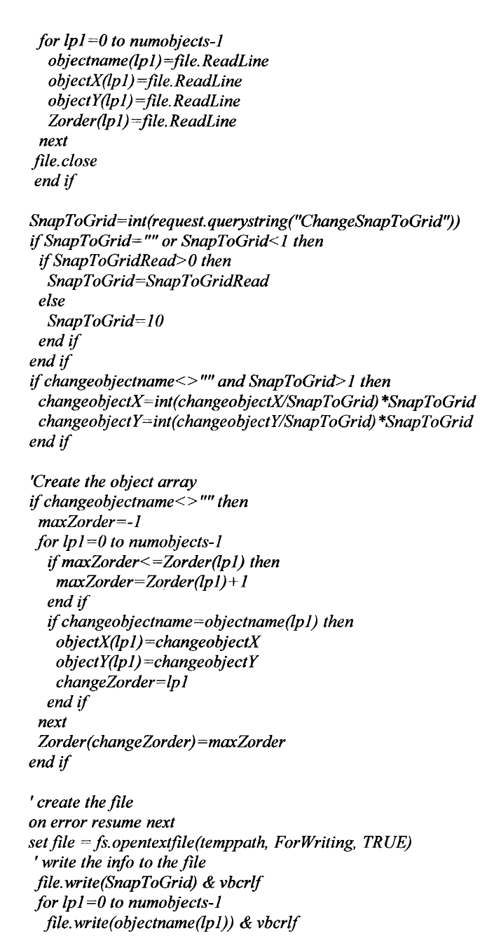

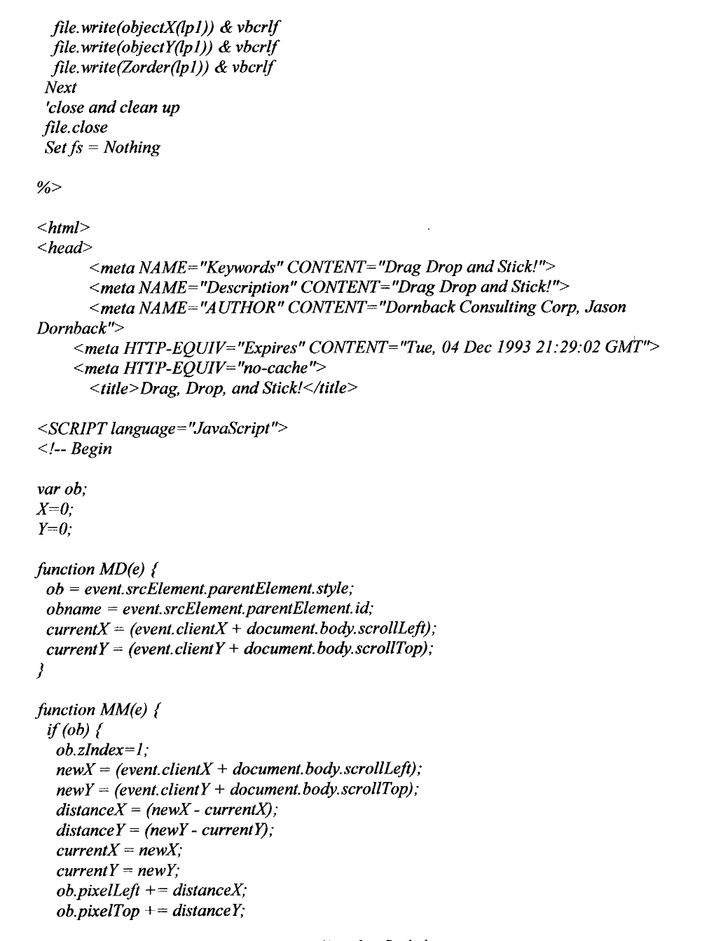

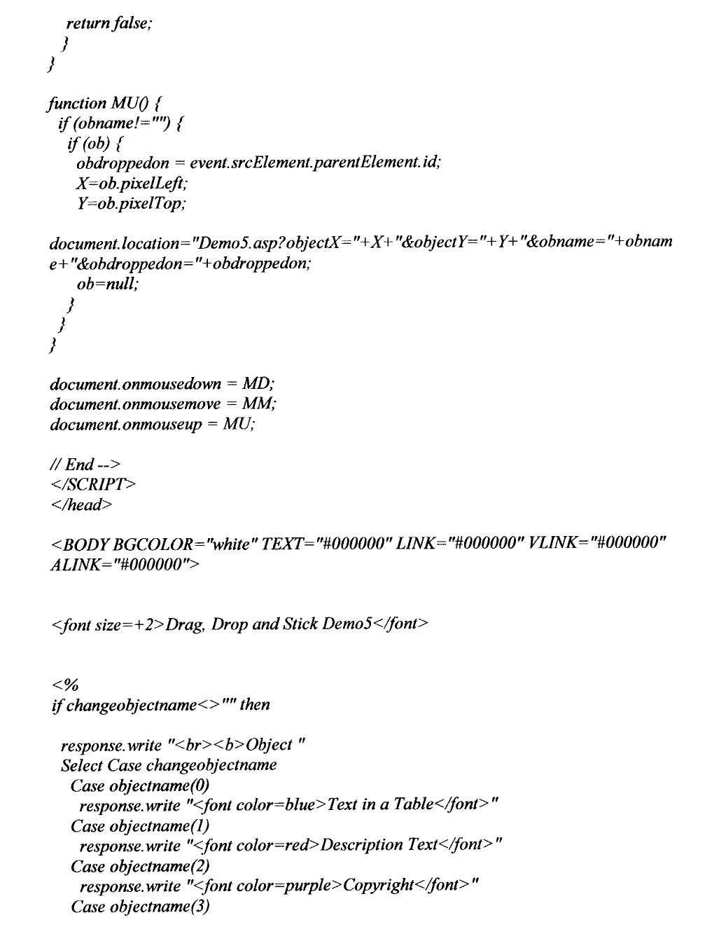

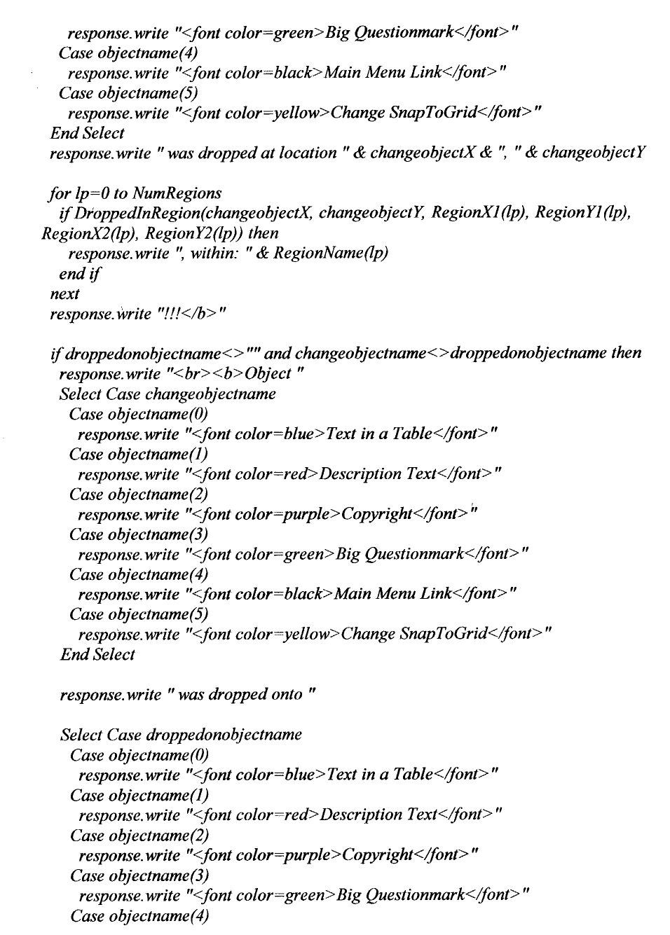

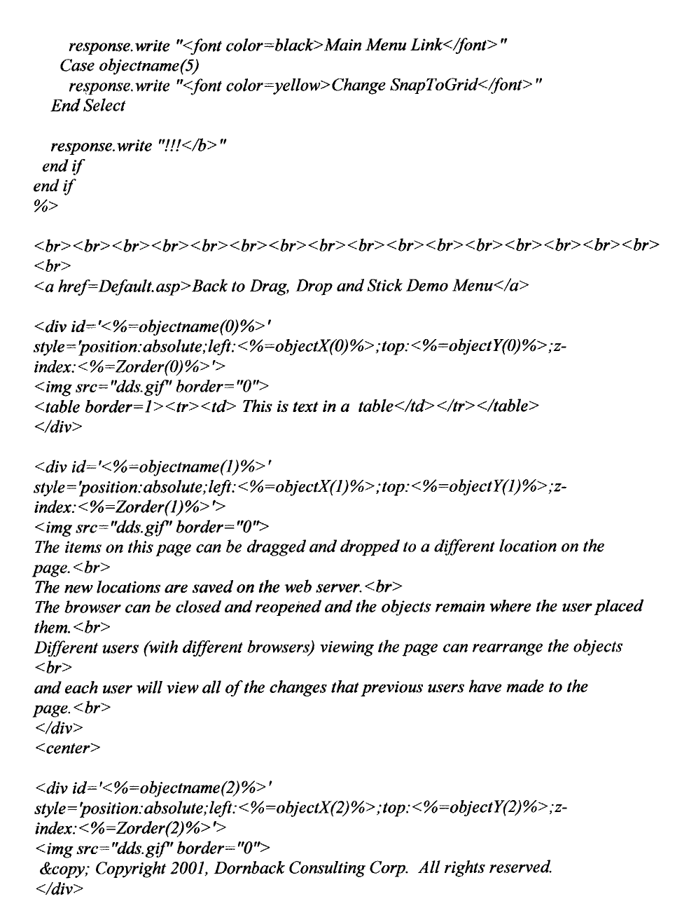

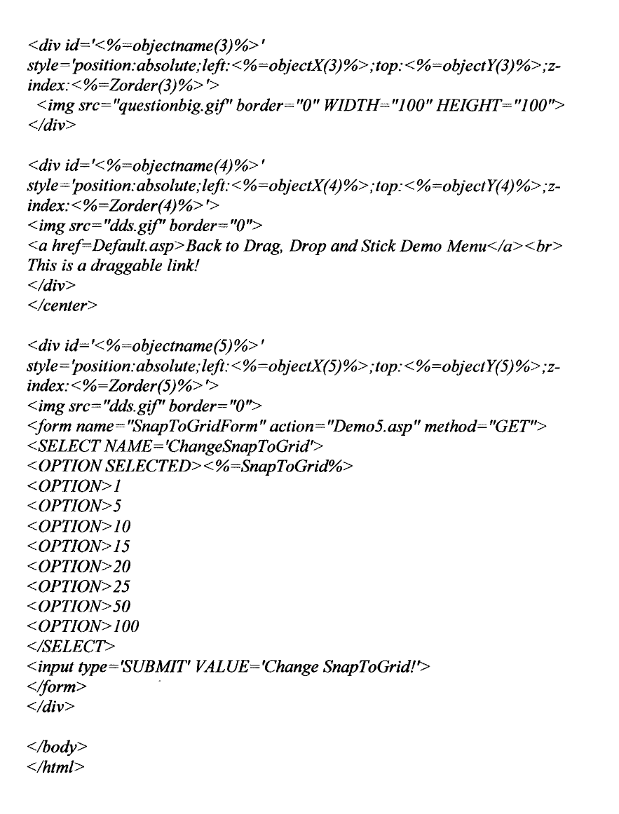

FIG. 7 shows the entire Demo5.asp sample code file. This sample code file is a combination of Active Server Pages, HTML, and javascript. This code demonstrates a variety of this inventions functionality:

How to define multiple objects within a web page. How multiple overlapping regions can be defined within a web page.

How to execute specific code if an object is dropped within region(s).

How to execute specific code if an object is dropped onto another object.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. It is therefore intended that the following appended claims be interpreted as including all such alterations, permutations, and equivalents as fall within the spirit and scope of the present invention.

What is claimed is:

1. The method of an action occurring as a result of dragging and dropping an object to a new location within a web page.

2. The method of claim 1, further comprising the objects that can be dragged are collections of web page code, including but not limited to:
(a) HTML Formatted text
(b) Images
(c) Hyperlinks
(d) Forms
(e) Tables
(f) Java Applets
(g) Java Script
(h) Flash content
(i) Shockwave content
(j) Video content

3. The method of claim 1, further comprising a specific action may be executed if the object is dropped within a defined region of the web page.

4. The method of claim 3, further comprising that a web page may contain multiple defined regions.

5. The method of claim 4, further comprising that the defined regions may overlap each other.

6. The method of claim 3, further comprising that different actions may be taken depending on which region is the target of the dropped object.

7. The method of claim 5, further comprising that if an object is dropped onto a location that is encompassed by multiple regions, different specific actions may be executed for each of the regions.

8. The method of claim 1, further comprising a specific action may be executed if the object is dropped onto another defined object on the web page.

9. The method of claim 1, further comprising that different actions may be taken depending on which object is dragged.

10. The method of claim 8, further comprising that different actions may be taken depending on which object is the target of the dropped object.

11. The method of claim 8, further comprising that if an object is dropped onto a location that is encompassed by multiple objects, different specific actions may be executed for each of the objects.

12. The method of claim 8, further comprising that if an object is dropped onto a location that is encompassed by region(s) and object(s), different specific actions may be executed for each of the region(s) and each of the object(s).
